(19) United States
(12) Patent Application Publication
(10) Pub. No.: US 2005/0145758 A1
(43) Pub. Date: Jul. 7, 2005

(54) KEY-IN ANCILLARY DEVICE

(76) Inventor: Tsung-Ming Chang, Taipei City (TW)

Correspondence Address: Tsung-Ming Chang, P.O. Box No. 6-57, Junghe, Taipei, 235, TW

(21) Appl. No.: 10/751,994

(22) Filed: Jan. 7, 2004

(51) Int. Cl. B43L 15/00

(52) U.S. Cl. 248/118.1; 248/118.5

(57) ABSTRACT

A key-in ancillary device comprising a main rail configured to be of a long strip form having uniform cross section, and having a bottom wall, two side walls of which perpendicularly extend from two sides thereof, and upper ends of each of the side walls are respectively horizontally extended inwards towards a center, thereby forming half-top walls. Two swivel tables are separately nested in the main rail, and two support blocks, having support pads configured atop thereof, are separately nested onto the respective swivel tables. During usage, an operator places their palms on the support blocks, and the swivel tables allow left and right sliding relative to the main rail, while the support blocks can swivel and move forward and backwards relative to the swivel tables, thereby accommodating key-in operations of a keyboard, reducing aching in the hands, and enabling the operator to work for prolonged periods of time.

### BACKGROUND OF THE INVENTION

(a) Field of the Invention

The present invention relates to a key-in ancillary device, and more particularly to providing the key-in ancillary device whereby hands of an operator can be so placed that a median nerve central of the wrists and forearms are straight and even and not subjected to pressure, and therefore wrists will not suffer from carpal tunnel syndrome.

Furthermore, forward, backward, left and right sliding movement of support blocks are so configured so as to exempt lifting of weakened hands, thereby reducing aching in the hands, and enabling the operator to work for prolonged periods of time.

(b) Description of the Prior Art

Accordingly, the computer has become a common sight in everyday life, and apart from bringing great expediency into lives of people, as regards industrial and commercial circles; computers have brought down costs and increased efficiency. Therefore, there are people who look upon upsurge of computers as another industrial revolution, which is not too far an exaggeration from actual truth.

Regarding operation of the computer, input is required to acquire output, and regardless of whether input comes from instructions or data, both equally rely on assistance of input devices in order to input such. Conventional input devices can be generally classified under keyboards, mice, handwriting, and so on. With regards to present input devices, we cannot but mention that the keyboard is still regarded as a fundamental input tool. This can be verified by the fact that all notebook type computers are still equally provided with the keyboard, and reason for ubiquitous utilization of the keyboard is because keyboard input relies on traditional typing habits of people. Therefore, an operator comparatively easily adapts to operating the computer, moreover, keystroke input is relatively more steady and accurate. Thus, up to the present, the keyboard is still regarded as an input tool of cardinal importance.

Because of extensive employment of the desktop computer, number of people suffering from use of the computer continues to increase. According to survey results carried out by the United States Department of Labor on injuries sustained from work fatigue, 4,400,000 patients suffer from injuries caused by usage of the computer alone, while nobody knows actual loss in business due to such occupational injuries.

Carpal tunnel syndrome is termed a modern epidemic, and is a disease paid most attention to among all work fatigue injuries resulting from using the computer. Primary reason being because carpal tunnel syndrome results in inconvenient body movement, and more seriously can even cause permanent damage to a median nerve, thereby consumedly restricting activity of the hand, and destroying muscle coordination.

So-called carpal tunnel syndrome (CTS) occurs in a very narrow circular protective passage of a wrist, Which is made up of bones and ligament, and has nine tendons, the median nerve and many blood vessels pass therethrough. This protective passage is termed the carpal tunnel. When the tendons passing through the carpal tunnel swell, the tendons press down on the median nerve, and carpal tunnel syndrome occurs thereof. A general orthopedist points out that while typing on the computer, as far as possible keep the wrists and forearms straight and even, and, in addition, prevent pressure from occurring on the wrist. Having the wrists lean against an edge of a hard table will result in putting pressure on the median nerve, and ultimately cause damage thereto, thus disabling muscles from functioning normally.

In light of above, the inventor of the present invention has investigated aforesaid with intensive personal attention over many years, as well as attentively and circumspectively carrying out research, and after three trials finally realized a key-in ancillary device as disclosed in the present invention.

### SUMMARY OF THE INVENTION

A primary objective of the present invention is to provide a key-in ancillary device enabling hands of an operator to rest comfortably on a tray-like design, thereby providing appropriate support for wrists thereof, each side of the key-in ancillary device being furnished with a rough pad, a soft pad, and a pad groove configured for the wrists to be placed atop. With the hands of the operator so placed, a median nerve central of the wrists and forearms are straight and even and not subjected to pressure, and therefore the wrists will not suffer from carpal tunnel syndrome. Furthermore, forward, backward, left and right sliding movement of support blocks do not require lifting of weakened hands, thereby reducing aching in the hands, and enabling the operator to work for prolonged periods of time.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows an exploded elevational view according to the present invention.

FIG. 2 shows an elevational view after assemblage according to the present invention.

### DETAILED DESCRIPTION OF THE PREFERRED EMBODIMENTS

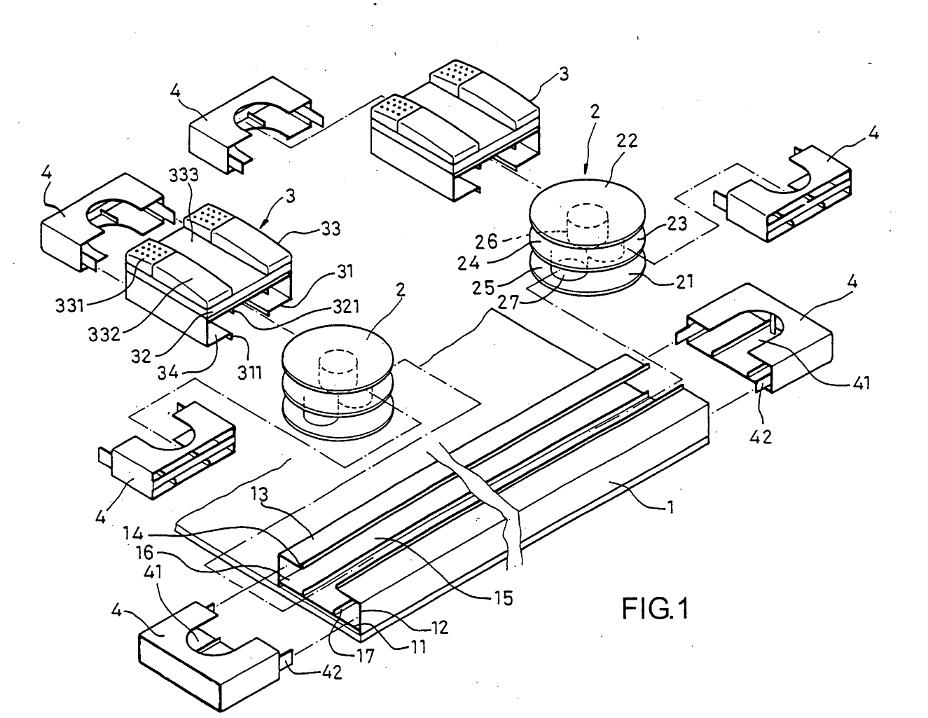

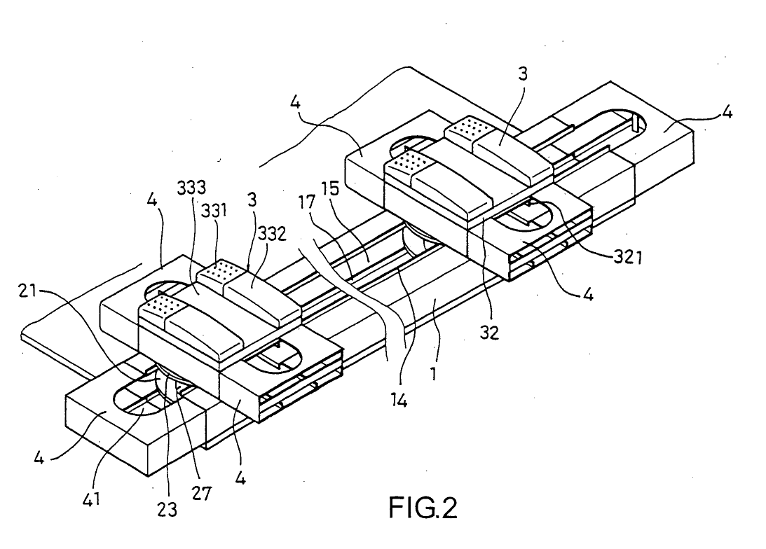

For further content disclosure of embodying art of the present invention see to FIGS. 1 and 2, wherein FIG. 1 shows an exploded elevational view according to the present invention, and FIG. 2 shows an elevational view after assemblage according to the present invention.

Referring to FIGS. 1 and 2, which show that basically the key-in ancillary device of the present invention is assembled to comprise a main rail 1, two swivel tables 2, two support blocks 3, and/or two end caps 4.

Wherein the main rail 1 is of a long strip form having uniform cross section, preferably fabricated by means of aluminum extrusion or plastic ejaculation, but not limited by such. The main rail 1 comprises a bottom wall 11, and two sidewalls 12 perpendicularly extended from two sides of the bottom wall 11. Ends of each sidewall 12 are respectively horizontally extended inwards towards a center thereof, thereby forming two half-top walls 13. Extremities of each of the half-top walls 13 are adapted to slightly protrude upwards from horizontal position, therewith forming wall flanges 14 to serve as line contacts for contact points of a bottom table 21 of each of the swivel tables 2. A top groove 15 is thus formed between the two half-top walls 13. Furthermore, walled grooves 16 are separately formed between the respective half-top walls 13 and the bottom wall 11. In addition, two upright bottom flanges 17 are configured on the bottom wall 11, therewith strengthening and serving as contacts with the swivel tables 2.

The swivel tables 2 respectively comprise the bottom table 21, and a top table 22, and a middle table 23 is configured therebetween, therewith partitioning the bottom table 21 and the top table 22. An upper groove 24 is thereby formed between the middle table 23 and the top table 22, and a lower groove 25 is formed between the middle table 23 and the bottom table 21. Furthermore, an upright upper post 26 is configured between and connects the top table 22 and the middle table 23, and lower posts 27 are configured between and connect the middle table 23 and the lower table 21. Thickness of the bottom table 21 corresponds to that of the aforementioned walled groove 16, thereby allowing nesting and sliding therein, moreover, the two lower posts 27 are configured to be rectilinear and for non-rotateable movement.

The support blocks 3 are respectively configured with two support rails 31, which are adapted to run in opposite direction to the main rail 1. Two sides of each of the support rails 31 respectively extend upright and connect to a support panel 32, and support pads 33 are respectively configured atop two sides of each support panel 32. A support groove 34 is thereby formed between the support panel 32 and the support rails 31 of each of the support blocks 3. Height of the support grooves 34 corresponds to thickness of the aforementioned top tables 22. In addition, to reduce contact surface, support flanges 311 are configured to downwardly protrude from an extremity of the support rails 31. Furthermore, panel flanges 321 are configured to downwardly protrude from an inner coping of the support panel 32 of each of the support blocks 3, and rough pads 331 functioning to provide a rubbing effect are configured on frontal sections of each of the support pads 33, and soft pads 332 fabricated from soft material are configured on a rear section of each of the support pads 33. A pad groove 333 is thus formed between the support pads 33 of each of the support blocks 3. During usage, the wrists can thereby straddle the pad grooves 333 and thus not arch.

The end caps 4 serve as plugs, and size of the end caps 4 are such to securely seal ends of the aforesaid main rail 1. A plug recess 41 is formed as a notch in a top surface of each of the end caps 4 thereof, and can function to lengthen sliding distance of the swivel tables 2. The end caps 4 integrate with the main rail 1 by means of two catches protruding from two sides of each of the end caps 4, clasping into the ends of the main rail 1 therewith. The end caps 4 are also configured to function in conjunction with the aforesaid support blocks 3 to serve as sliding stop blocks for the support blocks 3. In addition, an anti-slide pad is configured underneath the main rail 1, which alone, however, belongs to conventional art, and thus unnecessary to disclose details herein.

Again referring to FIGS. 1 and 2, when assembling the present invention, the swivel tables 2 are nested in the main rail 1 by means of the bottom tables 21 and the lower posts 27, whereupon the end caps 4 are plugged firmly into the two ends of the main rail 1. The two support blocks 3 are respectively nested onto the top tables 22 and the upper posts 26, and thereupon the swivel tables 2 assume a sliding configuration relative to the main rail 1. The support blocks 3 are also thus enabled to assume a swiveling configuration relative to the swivel tables 2.

When in usage, an operator can place their palms on the rough pads 331 of the support blocks 3, thus allowing fingers of the operator to strike keys of a keyboard, and a median nerve of the wrists is thereby positioned over the pad grooves 333, and therefore not subjected to pressure. The wrists of the operator can be placed on the soft pads 332 of the support blocks 3, and thus supported therewith. At the same time, the support blocks 3 can swivel and move forward and backwards relative to the swivel tables 2, and the swivel tables 2 can slide left and right relative to the main rail 1, thereby accommodating input requirements when striking the keyboard.

Accordingly, the embodiment of the key-in ancillary device as disclosed in the present invention enables heels of the hands to rest comfortable on a tray-like design, and provides the wrists with appropriate support, each side of the key-in ancillary device being furnished with the rough pad 331, the soft pad 332, and the pad groove 333 configured for the wrists to be placed atop. With the hands of the operator so placed, the median nerve central of the wrists and forearms are straight and even and not subjected to pressure, and therefore the wrists will not suffer from carpal tunnel syndrome. Furthermore, forward, backward, left and right sliding movement, does not require lifting of weakened hands, thereby reducing aching in the hands, and enabling the operator to work for prolonged periods of time.

In conclusion, all aspects of the present invention, including objective, artifice and effectiveness, demonstrate characteristics entirely different from those found in conventional art, and are foremost in actualizing practicability. The key-in ancillary device of the present invention thus conforms to patent criteria for a new model. Accordingly, a patent application is proposed herein.

It is of course to be understood that the embodiments described herein is merely illustrative of the principles of the invention and that a wide variety of modifications thereto may be effected by persons skilled in the art without departing from the spirit and scope of the invention as set forth in the following claims.

1. A key-in ancillary device, comprising:
a main rail, configured to be of a long strip form having uniform cross section, and having a bottom wall, two side walls of which perpendicularly extend from two sides thereof, and upper ends of each of the side walls are respectively horizontally extended inwards towards a center, thereby forming half-top walls, a top groove is thus formed between the half-top walls, furthermore, a walled groove is formed between the half-top walls and the bottom wall of each side of the main rail;
two swivel tables, which respectively comprise a bottom table, which connects to a middle table by means of two lower posts, and an upper post configured center of the middle table connects to a top table, whereby height of the lower table corresponds to that of the walled groove;
two support blocks, which are each respectively configured to comprise support rails, atop of which are connected to support pads, and two side support grooves are formed between the support rails, whereby height of the support grooves corresponds to thickness of the top table, the support pads are configured on two sides of each of the support blocks, a pad groove being formed therebetween;
the swivel tables are separately nested in the main rail by means of the respective bottom tables and lower posts, and the support rails separately nest on the respective top tables and upper posts thereof, when in usage, an operator can place their palms on the support blocks, and wrists of the operator thereby straddle the pad grooves, the swivel tables can slide left and right relative to the main rail, at the same time, the support blocks can swivel and move forward and backwards relative to the swivel tables, thereby accommodating key-in operations of a keyboard.

2. The key-in ancillary device according to claim 1, wherein each extremity of the main rail and the support block are further configured with an end cap, and adapted to function as a sliding stop-block.

3. The key-in ancillary device according to claim 1, wherein course rough pads are separately configured on respective frontal sections of the support pads of the support blocks, and soft pads are configured on each rear section thereof.

4. The key-in ancillary device according to claim 1, wherein the swivel tables are separately formed as single entities.

5. The key-in ancillary device according to claim 1, wherein upwardly protruding flanges are configured on extremities of the half-top walls of the main rail and bottom walls thereof.

6. The key-in ancillary device according to claim 1, wherein downwardly protruding flanges are configured on extremities of the support rails and support panels thereof.

7. The key-in ancillary device according to claim 1, wherein an anti-slide pad is configured underneath the main rail thereof.
